(19) United States
(12) Patent Application Publication
(10) Pub. No.: US 2003/0048016 A1
(43) Pub. Date: Mar. 13, 2003

(54) Thin motor and pump

(76) Inventor: Show-Way Yeh, Cupertino, CA (US)

Correspondence Address: Show-Way Yeh, 21845 Hermosa Ave., Cupertino, CA, 95014, US

(21) Appl. No.: 09/944,456

(22) Filed: Aug. 30, 2001

(51) Int. Cl. H02K 7/20; H02K 41/00

(52) U.S. Cl. 310/112; 310/12

(57) ABSTRACT

A number of elemental motors or the like are installed on a surface. Their movement is transferred to the actuator to drive the load. The elemental motors or the like can be as thin as desired. The number of the elemental motors or the like can be large to have desired power. Hence, the invented motor can be very thin With position detector, the actuator of the thin motor can make desired movement at desired moments of time. Installing a thin or small reservoir on the same surface to have the actuator drive the plunger of the reservoir, the pump can be thin and can deliver desired amount of liquid at desired moments of time. For medical application, the output medication is delivered into the user's body.

### FIELD OF THE INVENTION

The present invention relates to motors and pumps that are thin.

### PREVIOUS ARTS

| U.S. Pat. No. | Inventor | Date |
|---|---|---|
| 6210118 | Egawa | 4/3/01 |
| 6181050 | Taussig | 1/30/01 |
| 6179596 | Weisener | 1/30/01 |
| 5191251 | Paratte | 3/2/92 |
| 5189323 | Carr | 2/23/93 |
| 5187399 | Car | 2/16/93 |
| 5144183 | Farrenkopf | 9/1/92 |
| 5113100 | Taghezout | 5/12/92 |
| 5013954 | Shibaike | 5/7/91 |
| 4906884 | Teshigawara | 3/6/90 |
| 4829208 | Uchino | 5/9/89 |
| 4827175 | Kobayashi | 5/2/89 |
| 4374336 | Shimizu | 2/15/83 |
| 4035677 | Kusayama | 7/12/77 |
| 4012899 | Matsuura | 3/22/77 |

### BACKGROUND

All conventional electromagnetic motors, including rotational, linear, and flat motors, have cylinder type. All conventional pumps designed based on these motors are thick. The equipment, especially the medical devices, designed based on these pumps are thick, too. Some patients, like the type 1 diabetes, need medication constantly. The infusion pumps are good for them. However, the infusion pumps in the market are made of the conventional motors and, hence, are thick. They are not convenient to carry.

Micro motors based on silicone can be thin but have small power. The piezoelectric micropumps are thin. However, the technique is not stable, yet, the volume is usually small, and the pressure of the outlet is usually small.

The present invention uses the matured electromagnetic technique to design thin motors and pumps. It is composed of arbitrary number of, may be many, elemental motors or the like. Each elemental motor or the like is as thin as desired. The power of all elemental motors or the like is integrated so that the actuator of the overall apparatus is as thin as an elemental motor or the like and has desired power. The infusion pump using the thin motor can be thin. So, the patients can conveniently put the medication infusion pumps under their clothes.

### OBJECTS AND ADVANTAGES

My present invention presents conceptual models of thin motors. The pumps and other equipment that are based on these apparatuses can be thin and, hence, are more convenient to carry. For example, the medication infusion pumps can be put under the clothes.

### DRAWING FIGURES

FIG. 1: The conceptual structure of the thin motor having 8 linear motors.

FIG. 2: The enlarged actuator in FIG. 1.

FIG. 3: The position detector of the thin motor in FIG. 1.

FIG. 4: The timing diagram when linear motors in FIG. 1 change the current polarity.

FIG. 5: The conceptual structure of the thin motor having 6 coils reacting with 6 magnet rods or coils, respectively.

FIG. 6: The enlarged actuator in FIG. 5.

FIG. 7: The position detector of the thin motor in FIG. 5.

FIG. 8: The timing diagram when coils in FIG. 5 change the current polarity.

FIG. 9: The conceptual structure of the thin motor having 6 coils pulling 6 iron bars, respectively.

FIG. 10: The thin motors using flat motors as elemental motors.

FIG. 11: The thin motors using rotational motors as elemental motors.

FIG. 12: The conceptual structure of thin pump based on the flat motors.

FIG. 13: The inner bottom view of thin reservoir.

FIG. 14: The conceptual structure of thin pump based on the small rotational motors.

### REFERENCE NUMERALS IN DRAWINGS

10A to 10I: The coils or the elemental motors.

10X: Anyone of 10A to 10I.

20A to 20I: The magnet rods, coils, or the iron bars that react with the fields generated by 10A to 10I, respectively, to drive the actuator 50.

20X: Anyone of 20A to 20I.

30A to 30I: The coupling devices to transfer the movement of 20A to 20I, respectively, to the actuator 50.

30X: Anyone of 30A to 30I.

40A to 40I: The moveable joints to connect 30A to 30I and 20A to 20I, respectively.

40X: Anyone of 40A to 40I.

50: The actuator that drives the loads.

60: The position detector.

70: The load.

80A to 80F: The fixed joints of 30A to 30F, respectively, if there is.

80X: Anyone of 80A to 80F.

90A to 90F: The moveable joints of 30A to 30F, respectively, if there is.

90X: Anyone of 90A to 90F.

100: The reservoir.

110: The plunger of the reservoir.

120: The piston of the reservoir.

130 and 140: The inlet and the outlet valves, respectively.

### SUMMARY

A number of elemental motors or the like are installed on a surface. Their movement is transferred to the actuator to drive the load. The elemental motors or the like can be as thin as desired. The number of the elemental motors or the like can be large to have desired power. Hence, the invented motor can be as thin as the elemental motors or the like. Installing a thin or small reservoir on the same surface to have the actuator drive the plunger of the reservoir, the pump is thin and can deliver desired amount of liquid at desired moments of time. For medical application, the output medication is delivered into the user's body.

### DESCRIPTION

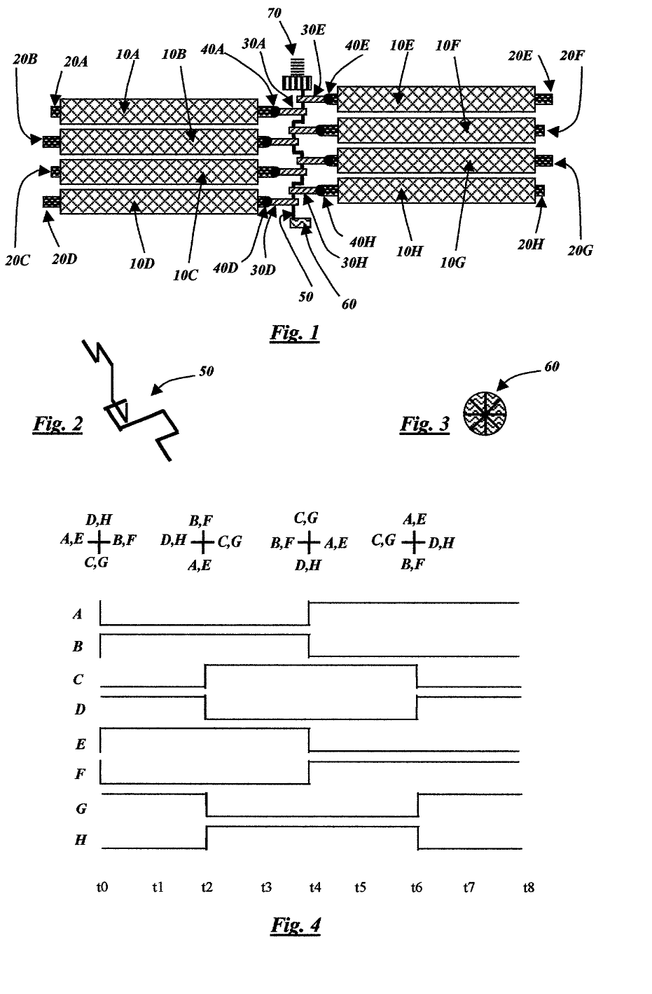

FIG. 1 shows the conceptual structure of a thin motor having 8 small linear motors that are arranged on a surface. So, the overall apparatus is as thin as the small linear motor. The linear motors have moveable magnet rods 20A, 20B, 20C, 20D, 20E, 20F, 20G, and 20H in the corresponding coils 10A, 10B, 10C, 10D, 10E, 10F, 10G, and 10H, respectively. When current is applied to the coil 10X, the generated electromagnetic field is either in the same or in the opposite direction with the magnetic field of the magnet rod 20X Therefore, controlling the direction of the current in the coil 10X will drive the magnet rod 20X to move back and forth.

Each magnet rod 20X is connected to its coupling device 30X with the moveable joint 40X Each coupling device 30X is connected to the actuator 50. FIG. 2 shows the enlarged actuator 50. So, the magnet rods 20A to 20H drive the actuator 50 to rotate. The actuator 50 then drives the load 70 to rotate.

FIG. 4 shows the timing diagram of when to change the polarity of the current in each coil to make the actuator 50 rotate counterclockwise assuming that positive polarity will make the magnet rod pull the actuator. As the figure shows, each coil 10X changes polarity when the corresponding part of the actuator 50 is at the nearest and at the farthest positions to make the actuator 50 continue to rotate. To rotate clockwise, the current in each coil 10X changes the polarity at the same position but with reverse polarity as counterclockwise rotating.

The position detector 60 detects the position of the actuator 50. Any device that can detect the position of the actuator 50 will work. FIG. 3 shows a simple position detector 60. The position detector 60 is divided into 8 fans. The controller can detect the position of the actuator 50 by detecting which fan touches the actuator 50.

Since the position detector 60 detects the position of the actuator 50, the controller may apply current to all coils 10A, 10B, 10C, 10D, 10E, 10F, 10G, and 10H from tₓ to t_{y} according to the timing diagram in FIG. 4. In the other words, the controller can control the load 70 to rotate any number of 1/8 turns in any direction at any time. This feature can be used to deliver exact amount of medication to the patient.

Note that the number of linear motors is arbitrary; and that the position detector 60 can be divided into n fans so that the load 70 can rotate any number of 1/n turns. An alternative is that each magnet rod 20X is replaced with a coil.

The thickness of the invented thin motor is determined by the diameter of the linear motors, the actuator, and the coupling devices. To make very thin motor, the linear motors are made as thin as possible. Then, the number of linear motors may be large to have the desired power.

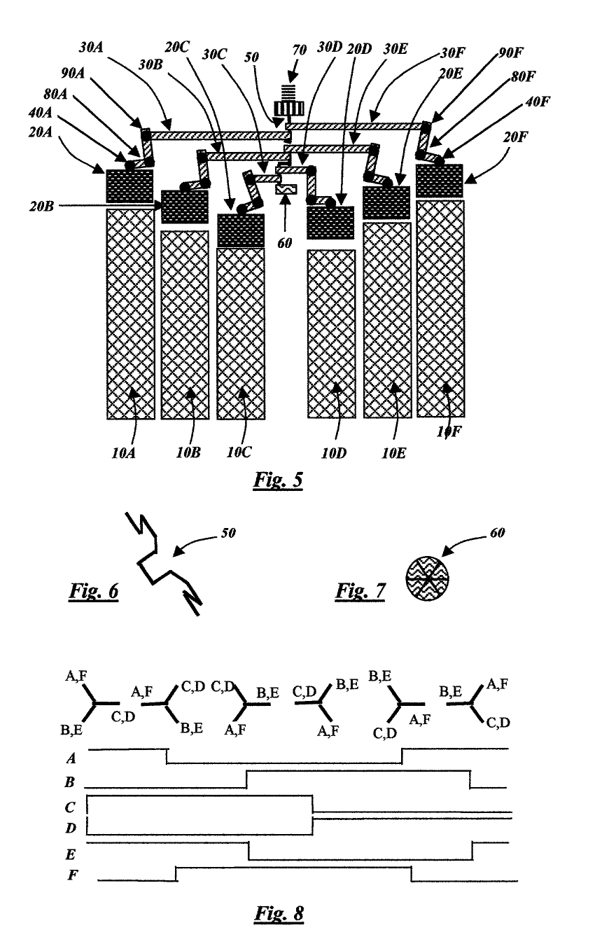

If the motor is required to be very thin, the linear motors may be too thin to be made. FIG. 5 shows an alternative way to make it. It scarifies the efficiency to trade for thinness. In FIG. 5, there are 6 coils 10A, 10B, 10C, 10D, 10E, and 10F. The magnet rods 20A, 20B, 20C, 20D, 20E, and 20F are moved out of the coils. Each magnet rod 20X is close to the coil 10X. When current is applied to the coil 10X, the generated magnetic field will push or pull the magnet rod 20X. The magnet rod 20X is connected to the coupling device 30X via a moveable joint 40X as above. Each coupling device 30X is connected to the actuator 50. Because of the orientation, each coupling device 30X has a fixed joint 80X and a moveable joint 90X. So, when the magnet rod 20X is pushed or pulled by the coil 10X, the actuator 50 is driven to rotate. FIG. 6 shows the actuator 50. FIG. 7 shows a simple position detector 60 that is divided into 6 fans and the controller can detect which fan touches the actuator 50. FIG. 8 shows the timing diagram of when to change the current to the coils to make the actuator 50 rotate counterclockwise. To make the actuator 50 rotate clockwise the polarities are reversed.

Note that the number of magnet rod 20X and coil 10X pairs is arbitrary and that the position detector 60 can be divided into n fans so that the load 70 can rotate any number of 1/n turns. Alternatives include that each magnet rod 20X is fixed and the coil 10X is moveable; that each magnet rod 20X is replaced with a coil; and both.

The efficiency of this kind of design is smaller than that of the previous one. However, since the magnet rods are removed from the coils, the coils can be significantly thinner than that of the previous design. Hence, the motor can be thinner than the previous one.

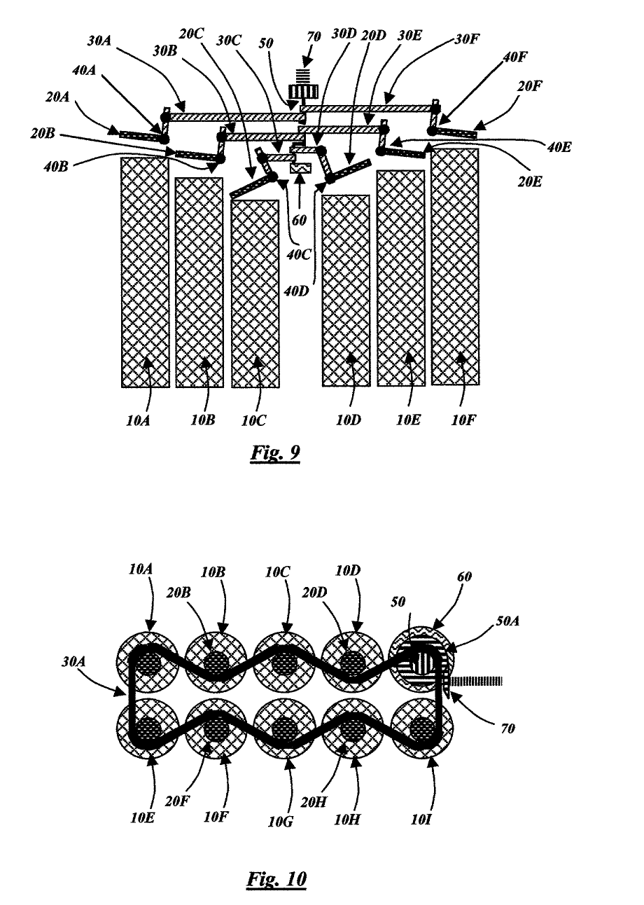

Another alternative is that the magnet rod is replaced by an iron bar as shown in FIG. 9. Then, the coil 10X can only pull but cannot push the iron bar 20X. The efficiency is even poorer but the motor is easier to make.

FIG. 10 shows the thin motor having 9 flat motors 10A to 10I as the elemental motors. The rotators 20A to 20I are linked by a belt or a chain 30A to the actuator 50. The actuator 50 has a gear 50A that drives the load 70. The position detector 60 determines the position of the actuator 50 so that the controller can determine how to supply each flat motors 10X electrical current.

FIG. 11 shows the thin motor having 8 rotational motors 10A to 10H as the elemental motors. Each rotator 20X of the rotational motor 10X has a coupling gear 30X The actuator 50 is a gear, too. The coupling gears 30A to 30H and the actuator 50 are in gear so that the 8 rotational motors 10A to 10H drives the actuator 50 that drives the load 70. The position detector 60 determines the position of the actuator 50 so that the controller can determine how to supply each rotational motors 10X electrical current.

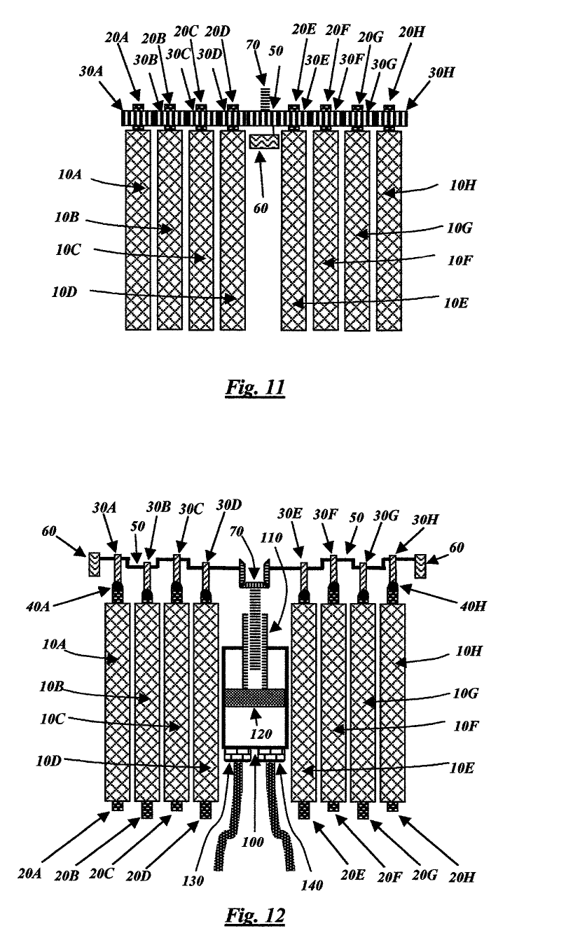

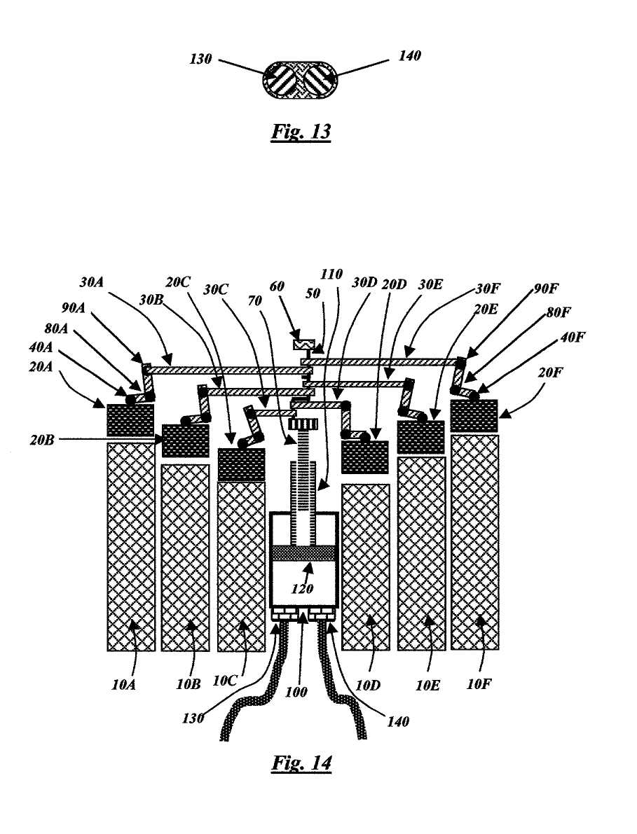

Coupling a fine or thin reservoir 100 to a thin motor, two thin pumps are shown in FIGS. 12 and 14 where the load 70 is a male screw that drives the plunger, a female screw, 110. The plunger 110 drives the piston 120 to move up and down. The inlet valve 130 and the outlet valve 140 will control the fluid to be drawn in and pressed out of the reservoir. FIG. 13 shows the inner bottom view of a thin reservoir.

### CONCLUSION

Accordingly, the readers will see that the thin motor disclosed in this invention can be very thin and can drive the actuator to move. Coupling with a thin or small reservoir, the apparatus can draw fluid, including medication, into the reservoir and press the fluid out of the reservoir. For medical application, the output medication is delivered into the user's body. The amount of output liquid can be controlled to be very fine. Comparing to the conventional motor and pumps, the apparatus using my invention can be very thin. It can be put under the user's closes and, hence, is much more convenient to be carried by the users.

Although the description above contains many specifications, these should not be constructed as limiting the scope of the invention but as merely providing illustrations of some of the presently preferred embodiments of this invention. Thus the scope of the invention should be determined by the appended claims and their legal equivalents, rather than by the examples given.

I claim:

1. A thin motor comprising:
installing a number of elemental movement generator means on a surface;
installing an actuator means on said surface;
installing transferring means to connect all said elemental movement generator means and said actuator means so that the movement of said elemental movement generator means is transferred to said actuator on said surface; and
installing controller means to control the movement of each said elemental movement generator means on said surface;
so that said controller means can make each said elemental movement generator means move and stop at desired moments of time and in the desired direction; the movement of each said elemental movement generator means is transferred to said actuator; and said actuator moves and stops at desired moments of time and in the desired direction.

2. The thin motor of claim 1 wherein:
each said elemental movement generator means is a linear motor;
so that the movement of each said linear motor starts and stops at desired moments of time and in the desired direction; the movement of said linear motors is transferred to said actuator; said actuator moves and stops at desired moments of time and in the desired direction.

3. The thin motor of claim 1 wherein:
each said elemental movement generator means is a rotational motor;
so that the movement of each said rotational motor starts and stops at desired moments of time and in the desired direction; the movement of said rotational motors is transferred to said actuator; said actuator moves and stops at desired moments of time and in the desired direction.

4. The thin motor of claim 2 wherein:
each said linear motor is composed of a moveable magnet rod in a fixed coil;
so that said controller means applies current to each said coil and stop doing it at desired moments of time; each said coil generates electromagnetic field to push and pull said magnet rod; the movement of said magnet rod is transferred to said actuator; said actuator moves and stops at desired moments of time and in the desired direction.

5. The thin motor of claim 2 wherein:
each said linear motor is composed of a moveable coil in a fixed coil;
so that said controller means applies current to each pair of said moveable coil and said fixed coil and stop doing it at desired moments of time; both said fixed coil and said moveable coil generate electromagnetic fields so that said fixed coil pushes and pulls said moveable coil; the movement of said moveable coil is transferred to said actuator of said thin motor; said actuator moves and stops at desired moments of time and in the desired direction.

6. The thin motor of claim 1 wherein:
each said elemental movement generator means is composed of a pair of a stator means and a mover means and they are close to each other;
so that said controller means can control each said pair of said actor means and said mover means to push and pull each other and stop doing it at desired moments of time; the movement of said mover means is transferred to said actuator of said thin motor; said actuator moves and stops at desired moments of time and in the desired direction.

7. The thin motor of claim 6 wherein:
each said stator means is a coil; and
each said mover means is a magnet rod;
so that said controller means applies current to each said coil and stop doing it at desired moments of time; each said coil generates electromagnetic field to push and pull said magnet rod; the movement of said magnet rod is transferred to said actuator of said thin motor; said actuator moves and stops at desired moments of time and in the desired direction.

8. The thin motor of claim 6 wherein:
each said stator means is a magnet rod; and
each said mover means is a coil;
so that said controller means applies current to each said coil and stop doing it at desired moments of time; each said coil generates electromagnetic field; each said coil is pushes and pulled by said magnet rod; the movement of said coil is transferred to said actuator of said thin motor; said actuator moves and stops at desired moments of time and in the desired direction.

9. The thin motor of claim 6 wherein:
each said stator means is a fixed coil; and
each said mover means is a moveable coil;
so that said controller means applies current to each pair of said fixed coil and said moveable coil and stops doing it at desired moments of time; each pair of said fixed coil and said moveable coil generate electromagnetic fields to push and pull each other; the movement of said moveable coil is transferred to said actuator of said thin motor; said actuator moves and stops at desired moments of time and in the desired direction.

10. The thin motor of claim 6 wherein:
each said stator means is a coil; and
each said mover means is an iron bar;
so that said controller means applies current to each said coil and stop doing it at desired moments of time; each said coil generates electromagnetic field to pull said iron bar; the movement of said iron bar is transferred to said actuator of said thin motor; said actuator moves and stops at desired moments of time and in the desired direction.

11. The thin motor of claim 6 wherein:
each said stator means is an iron bar; and
each said mover means is a coil;
so that said controller means applies current to each said coil and stop doing it at desired moments of time; each said coil generates electromagnetic field; each said coil is pulled by said iron bar; the movement of said coil is transferred to said actuator of said thin motor, said actuator moves and stops at desired moments of time and in the desired direction.

12. A thin pump comprising:
installing a thin motor on a surface;
installing a thin or small reservoir with plunger and piston on said surface; and
installing a transferring means to transfer the movement of the actuator of said thin motor to said plunger of said reservoir;
so that said actuator drives said plunger to move; said plunger drives said piston of said reservoir; and desired amount of fluid is drawn into said reservoir and is pressed out of said reservoir at desired moments of time.
